(19) United States
(12) Patent Application Publication
(10) Pub. No.: US 2025/0259179 A1
(43) Pub. Date: Aug. 14, 2025

(54) METHOD AND APPARATUS FOR DETECTING FRAUD

(71) Applicant: Dunamu Inc., Seoul (KR)

(72) Inventor: Minseob SO, Seoul (KR)

(73) Assignee: Dunamu Inc., Seoul (KR)

(21) Appl. No.: 19/051,331

(22) Filed: Feb. 12, 2025

(30) Foreign Application Priority Data
Feb. 14, 2024 (KR) 10-2024-0021040

(51) Int. Cl. G06Q 20/40; G06Q 20/10

(52) U.S. Cl. CPC G06Q 20/4016; G06Q 20/10

(57) ABSTRACT

Disclosed is a method of detecting a fraud. The corresponding method may include receiving, from a first user terminal corresponding to a first user account, a withdrawal request for transmitting digital assets to an address of a second user account, acquiring a fraud risk for the withdrawal request by inputting, into a first model, transaction log information between the first user account and the second user account and a time interval between a time point of a last deposit in an address of the first user account and a time point of the withdrawal request, performing a process for the withdrawal request based on the fraud risk, generating training information corresponding to the withdrawal request based on the fraud risk, and training the first model based on the training information.

### CROSS-REFERENCE TO RELATED APPLICATION

This application is based upon and claims the benefit of priority from Korean Patent Application No. 10-2024-0021040, filed on Feb. 14, 2024, the entire contents of which are incorporated herein by reference.

### TECHNICAL FIELD

The present disclosure relates to a technique for detecting fraud.

### BACKGROUND

In asset trading markets such as financial markets, various approaches to fraud detection are being attempted. A fraud detection system can be used to prevent various types of fraud in various environments such as financial transactions provided by financial institutions or banks, online payments provided by e-commerce platforms or credit card companies, and financial services. Such a system may serve to protect assets of customers and corporations and maintain safety of the financial system.

### SUMMARY

At least one embodiment disclosed herein provides a technology for identifying whether a withdrawal request is fraudulent by using a machine learning-based model.

At least one embodiment disclosed herein provides a technology for generating training information related to a withdrawal request identified as a fraud and update the model, based on the generated training information.

At least one embodiment disclosed herein provides a technology for performing an authentication procedure for a withdrawal request suspected of being a fraud among withdrawal requests.

At least one embodiment disclosed herein provides a technology for generating training information related to a withdrawal request that has not been authenticated and update the model, based on the generated training information.

At least one embodiment disclosed herein provides a technology for determining a contribution to determination of a fraud risk for the withdrawal request.

Technical aspects disclosed herein are not limited to the technical aspects mentioned above, and other technical aspects not mentioned will be clearly understood by those skilled in the art to which the present disclosure pertains from the following description.

A method according to an embodiment may include, by one or more processors, receiving, from a first user terminal corresponding to a first user account, a withdrawal request for transmitting digital assets to an address of a second user account, acquiring a fraud risk for the withdrawal request by inputting, into a first model, transaction log information between the first user account and the second user account and a time interval between a time point of a last deposit in an address of the first user account and a time point of the withdrawal request, performing a process for the withdrawal request, based on the fraud risk, generating training information corresponding to the withdrawal request, based on the fraud risk, and training the first model, based on the training information.

The first model according to an embodiment may be a model trained based on training information having, as input information, transaction log information between two user accounts among a plurality of user accounts and a time interval between a time point of a last deposit in an address of one of the two user accounts and a time point of a withdrawal request, and wherein the training information has, as label information, a classification result indicating whether the input information is fraudulent.

The performing a process for the withdrawal request according to an embodiment may include determining whether the fraud risk is higher than or equal to a first threshold risk and transmitting, to the first user terminal, information indicating that the withdrawal request is rejected, based on a determination that the fraud risk is higher than or equal to the first threshold risk, and transmitting digital assets corresponding to the withdrawal request to the address of the second user account, based on a determination that the fraud risk is lower than the first threshold risk.

The generating of the training information corresponding to the withdrawal request according to an embodiment may include generating first training information corresponding to the withdrawal request, based on the determination that the fraud risk is higher than or equal to the first threshold risk.

The training of the first model, based on the training information, according to an embodiment, may include training the first model, based on the first training information.

The performing a process for the withdrawal request according to an embodiment may include determining whether the fraud risk is higher than or equal to a second threshold risk, based on a determination that the fraud risk is higher than or equal to the second threshold risk, performing an authentication procedure for the withdrawal request, determining whether the withdrawal request is authenticated based on the authentication procedure, and transmitting, to the first user terminal, information indicating the withdrawal request is rejected, based on a determination that the withdrawal request is not authenticated based on the authentication procedure, and transmitting digital assets corresponding to the withdrawal request to the address of the second user account based on a determination that the withdrawal request is authenticated based on the authentication procedure.

The generating of the training information corresponding to the withdrawal request according to an embodiment may include generating second training information corresponding to the withdrawal request, based on the determination that the withdrawal request is not authenticated based on the authentication procedure.

The training the first mode, based on the training information, according to an embodiment, may include training the first model, based on the second training information.

The generating of the second training information corresponding to the withdrawal request according to an embodiment may include determining, as the second training information, label information indicating that the transaction log information, the time interval, and the withdrawal request are fraudulent.

The generating of the second training information corresponding to the withdrawal request according to an embodiment may include determining whether a transaction pattern corresponding to the transaction log information, the time interval, and the withdrawal request is at least one of predetermined fraud patterns and determining, as the second training information, label information indicating that the transaction log information, the time interval, and the withdrawal request are fraudulent, based on determination that the transaction pattern does not correspond to the fraud patterns.

The acquiring of the fraud risk for the withdrawal request according to an embodiment may include acquiring the fraud risk by inputting an input information set related to the withdrawal request into the first model. The input information set may include at least one piece of input information selected from a time point of the withdrawal request, a type of digital asset requested to be withdrawn, a specificity of the withdrawal request, an amount obtained by converting digital assets requested to be withdrawn into a value of legal tender, a type of a wallet of the first user account, a number of logins to the first user account, deposit information in the address of the first user account for a predetermined period, or withdrawal information from the address of the first user account for a predetermined period.

The acquiring of the fraud risk for the withdrawal request according to an embodiment may further include determining the specificity of the withdrawal request, based on a deposit-withdrawal pattern shown in a deposit-withdrawal record of the first user account for a preset period.

The specificity of the withdrawal request according to an embodiment may indicate a degree of dissimilarity between the withdrawal request and the deposit-withdrawal pattern, and the fraud risk acquired from the first model may increase in proportion to the specificity of the withdrawal request.

The acquiring of the fraud risk for the withdrawal request according to an embodiment may further include determining a time section corresponding to the time point of the withdrawal request among a plurality of time sections and acquiring the fraud risk by further inputting information indicating the determined time section into the first model.

The acquiring of the fraud risk for the withdrawal request according to an embodiment may include determining a digital asset classification corresponding to the digital assets requested to be withdrawn among digital asset classifications based on a trading volume and acquiring the fraud risk by further inputting information indicating the determined digital asset classification into the first model.

The acquiring of the fraud risk for the withdrawal request according to an embodiment may further include determining a wallet classification corresponding to an address of the second user account among wallet classifications based on a number of transactions recorded within a predetermined time interval and acquiring the fraud risk by further inputting information indicating the determined wallet classification into the first model.

The method according to an embodiment may further include acquiring contribution information indicating a contribution of each of the transaction log information and the time interval to determination of the fraud risk by inputting the first model, the transaction log information, and the time interval into a second model and transmitting the contribution information to the first user terminal.

The second model according to an embodiment may be a model trained to input a plurality of combinations of the transaction log information and the time interval into the first model and acquire contribution information of each of the transaction log information and the time interval, based on a fraud risk acquired for each of the combinations.

The method according to an embodiment may further include inputting the input information set into a second model and acquiring contribution information indicating a contribution of each piece of input information in the input information set to determination of the fraud risk and transmitting the contribution information to the first user terminal.

The second model according to an embodiment may be a model trained to acquire contribution information for each piece of the input information, based on a fraud risk acquired for each of a plurality of combinations of the input information by inputting the plurality of combinations of the input information into the first model.

The method according to an embodiment may further include generating third training information corresponding to the withdrawal request, based on the contribution information and training the first model, based on the third training information.

The generating of the third training information according to an embodiment information may include generating the third training information such that a weight is set to be higher as a contribution of indicated input information is larger, based on the contribution information.

An electronic device according to another embodiment may include one or more processors and one or more memories configured to store at least one instruction executed by the one or more processors, wherein the one or more processors may be configured to execute the at least one instruction to receive, from a first user terminal corresponding to a first user account, a withdrawal request for transmitting digital assets to an address of a second user account, acquire a fraud risk for the withdrawal request by inputting, into a first model, transaction log information between the first user account and the second user account and a time point of a last deposit in an address of the first user account, perform a process for the withdrawal request, based on the fraud risk, generate training information corresponding to the withdrawal request, based on the fraud risk, and train the first model, based on the training information.

A non-transitory computer-readable recording medium recording at least one instruction executed by one or more processors according to another embodiment is provided. The at least one instructions may cause the one or more processors to receive, from a first user terminal corresponding to a first user account, a withdrawal request for transmitting digital assets to an address of a second user account, acquire a fraud risk for the withdrawal request by inputting, into a first model, transaction log information between the first user account and the second user account and a time point of a last deposit in an address of the first user account, perform a process for the withdrawal request, based on the fraud risk, generate training information corresponding to the withdrawal request, based on the fraud risk, and train the first model, based on the training information.

### BRIEF DESCRIPTION OF DRAWINGS

The accompanying drawings, which are incorporated in and constitute a part of the specification, illustrate embodiments of the present disclosure.

FIG. 1 illustrates an environment to which devices according to an embodiment of the present disclosure can be applied.

FIG. 2 is a block diagram of a server according to an embodiment of the present disclosure.

FIG. 3 is a diagram illustrating a method of calculating a fraud risk and contribution information according to an embodiment of the present disclosure.

FIG. 4 is a diagram illustrating a method of processing input information according to an embodiment of the present disclosure.

FIG. 5 is a flowchart illustrating a method of generating first training information according to an embodiment of the present disclosure.

FIG. 6 is a flowchart illustrating a method of generating second training information according to an embodiment of the present disclosure.

FIG. 7 is a diagram illustrating contribution information when a withdrawal request is a fraudulent according to an embodiment of the present disclosure.

FIG. 8 is a diagram illustrating contribution information when a withdrawal request is normal according to an embodiment of the present disclosure.

FIG. 9 is a flowchart illustrating a method of detecting a fraud according to an embodiment of the present disclosure.

### DETAILED DESCRIPTION

Various embodiments disclosed herein are illustrated for clearly describing the technical idea of the present disclosure, and are not intended to limit the present disclosure to specific embodiments. The technical idea of the present disclosure includes various modifications, equivalents, and alternatives of each embodiment disclosed herein and a selective combination from all or part of the embodiments. Further, the scope of the technical idea of the present disclosure is not limited to various embodiments to be illustrated below or a specific description thereof.

Unless otherwise defined, all terms including technical and scientific terms used herein may have the same meaning as commonly understood by a person having ordinary knowledge in the art to which the present disclosure belongs.

The expressions “include,” “may include,” “provided with,” “may be provided with,” “have,” and “may have” used herein refer to the existence of a corresponding feature (e.g., a function, an operation, or a constituent element), and do not exclude the existence of one or more additional features. That is, these expressions should be understood as open-ended terms connoting the possibility of inclusion of other embodiments.

A singular expression used herein may include meanings of a plurality unless otherwise mentioned, and the same is applied to a singular expression recited in the claims.

Unless otherwise defined, the expressions “a first” and “a second” or “the first” and “the second” used herein are used to distinguish one component from another component in referring to a plurality of components of the same kind, and are not intended to limit the order or importance of components.

The expression “A, B, and C,” “A, B, or C,” “at least one A, B, and C,” or “at least one of A, B, or C” used herein may refer to respective listed items or all possible combinations of the listed items. For example, the expression “at least one of A or B” may refer to all of (1) at least one A, (2) at least one B, or (3) at least one A and at least one B.

The expression “based on” used herein is used to describe one or more factors that influence a decision, an action of judgment, or an operation described in a phrase or sentence including the relevant expression, and does not exclude an additional factor influencing the decision, the action of judgment, or the operation.

It will be understood that when a certain component (e.g., a first component) is described as being “coupled to” or “connected to” another component (e.g., a second component), the certain component may be coupled or connected directly to the other component, or the certain component may be coupled or connected to the other component via a new intervening component (e.g., a third component).

The expression “configured to” used herein may have a meaning of “set to,” “having the capacity to,” “changed to,” “made to,” or “capable of” according to context. This expression is not limited to a meaning of “specifically designed in hardware.” For example, a processor configured to perform a specific operation may refer to a generic-purpose processor capable of performing the specific operation by executing software, or may refer to a special-purpose processor structured through programming to perform the specific operation.

The term “asset trading platform” used herein is an online platform used to trade various assets. The asset trading platform may provide investors with opportunities to trade and invest various financial products and assets. The asset trading platform processes trading of stocks, bonds, foreign exchange, digital assets (for example, cryptocurrencies), raw materials, and derivatives. Various characteristics and regulations may be applied to the asset trading platform according to each asset item. The asset trading platform may provide an order execution function, a real-time market price information provision function, a technical analysis and chart provision function, and the like. The order execution function is a function that allows users to trade assets by using various types of orders such as market orders, limit orders, and stop orders. The real-time market price information provision function may be a function that provides information on the price and the trading volume of assets in real time. The technical analysis and chart provision function may refer to tools that help users to analyze the price movement of assets and predict future price fluctuation. The asset trading platform may provide users (for example, investors) with convenient ways to trade various asset types and help the users develop investment strategies and explore financial markets.

In the present disclosure, digital assets may be various types tokens such as “Bitcoin,” “Ethereum,” “Ripple,” “ADA,” “Dogecoin,” “non-fungible tokens,” and “security tokens.”

The term “trading volume” used herein may be an index indicating a total amount of trading of specific assets (for example, stocks, bonds, currencies, digital assets, and the like) for a specific period in the asset trading platform. The trading volume may be determined based on various measurement units. For example, the trading volume may be determined based on the number of specific items traded. For example, in a case where 100 digital assets are traded, the trading volume may be 100. In another example, the trading volume may be determined by the trading value. For example, the trading volume may be converted in units of legal tender and, when the conversion value of 100 digital assets is 1 million won, the trading volume may be 1 million won.

The term “withdrawal request” used herein may be a request for retrieving assets from a user's bank account (or a wallet address in the case of digital assets). For example, when the withdrawal request is a deposit withdrawal request, the amount of money requested by the user may be withdrawn from the bank account.

The term “legal tender” used herein means a currency that is legally recognized in one country and used for legal transactions. Each country may designate a currency established by law as its legal tender and use the same as the standard for economic activities and transactions. For example, in the United States, the US dollar (USD) may be used as legal tender.

The term “address” used herein may be a digital asset wallet address. Accordingly, when a withdrawal request for transmitting digital assets from a first user account to an address of a second user account is received by a server, the digital assets may belong to the address of the second user account (or a digital asset wallet address). A digital asset wallet may be a tool for safely storing and managing personal digital assets in an electronic form. The digital asset wallet may store and manage information related to cryptocurrencies or digital assets. The digital asset wallet may be classified into a hot wallet and a cold wallet. The hot wallet is a wallet connected to the Internet, which allows access to a cryptocurrency in an online environment. Generally, the hot wallet may be provided as a software wallet or an online service. The hot wallet may provide convenient and quick access to transmit a cryptocurrency, and may process a transaction quickly. The cold wallet may be a wallet that stores a private key in an offline environment which is not connected to the Internet. Generally, the cold wallet may be provided as a hardware wallet or a paper wallet. The cold wallet may securely protect the private key and store the private key offline, thus providing a high level of security against hacking or attacks from malicious software.

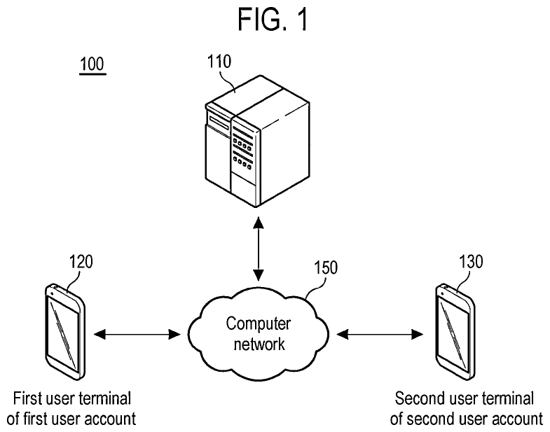

FIG. 1 illustrates an environment in which devices according to an embodiment of the present disclosure can be applied. The environment may include at least one of a server 110, a first user terminal 120 of a first user account, a second user terminal 130 of a second user account, or a computer network 150. The first user account may be an account that transmits digital assets to an address of the second user account, and the second user account may be an account that receives digital assets corresponding to a withdrawal request from the first user account. The first user account and the second user account are separated for convenience of description, and roles of the first user account and the second user account may be interchanged.

The server 110, the first user terminal 120, and the second user terminal 130 may communicate with each other through the computer network 150. The computer network 150 refers to a digital electric communication network, which connects various distributed devices through a predetermined communication network. The computer network 150 may be configured as any type of wired or wireless network, such as a local area network (LAN), a wide area network (WAN), a mobile radio communication network, or a wireless broadband Internet (WiBro). Although FIG. 1 shows an environment in which the server 110 communicates with two user terminals 120 and 130 through the computer network 150, which is merely an example, the number of user terminals may vary.

The server 110 may be a server of an asset trading platform. That is, the server 110 may be a server that operates according to management of an entity for operating the asset trading platform. The server 110 may provide various services which are provided to users in the asset trading platform. For example, the server 110 may process requests from users who access the asset trading platform. In addition to the exemplary processing, the server 110 may perform various processing for operating and managing the asset trading platform. For example, the server 110 may monitor a present status of a transaction performed in the asset trading platform.

The server 110 may be implemented as one or more computing devices. For example, all functions of the server 110 may be implemented in a single computer device. In another example, a first function of the server 110 may be implemented in a first computing device, and a second function distinguished from the first function may be implemented in a second computing device distinguished from the first computing device. For example, the computing device may be a desktop computer, a laptop computer, an application server, a proxy server, a cloud server, or the like, but is not limited thereto and may include all types of devices having a computing function.

Hereinafter, an embodiment of a process in which the server 110 detects a fraud is described.

The server 110 may receive a withdrawal request for transmitting digital assets to the address of the second user account from the first user terminal 120 corresponding to the first user account. The withdrawal request may be a request for making a change such that at least a portion of the digital assets belonging to the first user account is owned by the second user account.

The server 110 may acquire a fraud risk for the withdrawal request by inputting transaction log information between the first user account and the second user account and a time interval between a time point of the last deposit in the address of the first user account and a time point of the withdrawal request to a first model. The transaction log information between the first user account and the second user account may include log information related to transactions generated between the first user account and the second user account. For example, the transaction log information may include the number of transactions between the first user account and the second user account, a transaction period and trading value between the first user account and the second user account, the number of withdrawals to the second user account for a predetermined period, types of traded digital assets, and the like. The time point of the last deposit in the address of the first user account may be a time point of the most recent deposit of digital assets in the address of the first user account. The time point of the withdrawal request may be a time point at which a request for transfer to the address of the second user account is made to the first user account. The time interval may be a difference between the time point of the last deposit and the time point of the withdrawal request. For example, when the time point of the last deposit is 14:00 on Jan. 3, 2024 and the time point of the withdrawal request is 13:40 on Jan. 3, 2024, the time interval may be 20 minutes.

The fraud risk may indicate a degree of the withdrawal request being determined to correspond to a fraudulent pattern. The higher the likelihood that a specific withdrawal request is fraudulent, the higher the fraud risk. The transaction pattern may be repetitive actions or trends observed in the transaction behavior of users in the asset trading market. The patterns are reflection of individual judgment and strategies that emerge from users and are often observed in a specific situation or a market condition. The fraud pattern may be a trading pattern that is manifested by actions or behaviors different from the normal trading pattern.

For example, when the number of transactions between the first user account and the second user account is 1 and there is no log of transactions between the first user account and the second user account for a long period, the server 110 may acquire a high fraud risk by using the first model. This is because the case where there is a withdrawal request despite a low transaction frequency between the first user account and the second user account has a possibility of corresponding to the fraud pattern. In the case of voice phishing, a victim of the voice phishing may not have had any previous transactions with a perpetrator in the past.

In another example, as the time interval between the time point of the last deposit in the address of the first user account and the time point of the withdrawal request becomes longer, the server 110 may acquire a lower fraud risk by using the first model. This is because the longer time interval is less likely to correspond to the fraud pattern. The case where digital assets are transferred to the second user account once the digital assets are deposited in the address of the first user account is highly likely to correspond to the fraud pattern. For example, in the case of voice phishing, victims of the voice phishing are highly likely to make a withdrawal request for immediately transmitting their own assets to an address of the perpetrator once the assets are deposited in their own bank accounts (or addresses).

The first model may be a model trained based on training information having, as input information, transaction log information between two user accounts among a plurality of user accounts and a time interval between a time point of the last deposit in one of the two user accounts and a time point of a withdrawal request and, as label information, a classification result indicating whether the input information is fraudulent. The label information may indicate whether the input information is fraudulent. The first model may be a model that trained a correlation between the input information and the label information. For example, the first model may include a decision tree, a classification and regression tree, a gradient boosting tree, a random forest, and the like. The input information is only an example, and other information may be additionally used.

In an embodiment, the server 110 may process the withdrawal request, based on the fraud risk. Processing the withdrawal request may mean transmitting digital assets corresponding to the withdrawal request to a specific user account in response to the withdrawal request. The server 110 may determine whether the fraud risk is higher than or equal to a threshold risk. The server 110 may reject the withdrawal request according to determination that the fraud risk is higher than or equal to the threshold risk. Further, the server 110 may transmit information indicating that the withdrawal request has been rejected to the first user terminal 120. The server 110 may transmit the digital assets corresponding to the withdrawal request to the address of the second user account according to determination that the fraud risk is lower than the threshold risk.

In an embodiment, the server 110 may generate training information corresponding to the withdrawal request, based on the fraud risk. The server 110 may generate training information corresponding to the withdrawal request according to determination that the fraud risk is higher than or equal to the threshold risk. The withdrawal request higher than or equal to the threshold risk may correspond to the existing fraud pattern or correspond to a new fraud pattern. In an embodiment, the server 110 may identify whether a withdrawal request is an existing fraud pattern or a new fraud pattern and generate training information corresponding to the withdrawal request only when the withdrawal request corresponds to the new fraud pattern. In another example, the server 110 may generate training information corresponding to a withdrawal request according to determination that the fraud risk is higher than or equal to the threshold risk regardless of whether the withdrawal request is an existing fraud pattern or a new fraud pattern.

The server 110 may generate training information corresponding to a withdrawal request in order to train the first model based on a new fraud pattern. In a process of generating the training information, it may be determined that the input information of the first model is the corresponding withdrawal request and the label information indicates that the withdrawal request is fraudulent. Further, the training information may include, as input information of the first model, transaction log information between a first user account and a second user account corresponding to the corresponding withdrawal request, a time interval between a time point of the last deposit in an address of the first user account and a time point of the withdrawal request, a time point of the withdrawal request, a type of digital assets, a specificity of the withdrawal request, an amount obtained by converting digital assets into a value of legal tender, a type of a wallet of the first user account, the number of logins to the first user account, deposit information in the address of the first user account for a predetermined period, or withdrawal information from the address of the first user account for a predetermined period. The server 110 may train the first model based on the training information. Accordingly, the server 110 may train a new fraud pattern in consideration of various pieces of input information related to a specific withdrawal request.

The user terminals 120 and 130 may be terminals of users using the asset trading platform. In the present disclosure, the user terminals 120 and 130 may be interchangeably used with terminals or terminals of users. In an embodiment, a web browser or an application may be installed in the user terminals 120 and 130 to allow the users to use the asset trading platform. The user terminals 120 and 130 may be, for example, one of desktop computers, laptop computers, tablet computers, wearable devices, or smartphones but are not limited to the examples, and all types of devices having computing functions may be included in the computing devices.

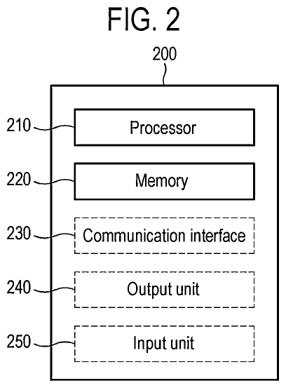

FIG. 2 is a block diagram of the server 110 according to an embodiment of the present disclosure. The server 110 may include one or more processors 210 and/or one or more memories 220. In an embodiment, at least one element of the server 110 may be omitted, or other elements may be added to the server 110. In an embodiment, additionally or alternatively, some elements may be integrated or implemented as a single or a plurality of entities.

In the present disclosure, one or more processors 210 may be referred to as the processor 210. The processor 210 may a set of one or more processors, unless otherwise specified clearly in context. Further, in the present disclosure, one or more memories 220 may be referred to as the memory 220. The term “memory 220” may be a set of one or more memories, unless otherwise specified clearly in context. In an embodiment, at least some elements inside/outside the server 110 may be connected to each other through a bus, general purpose input/output (GPIO), a serial peripheral interface (SPI), a mobile industry processor interface (MIPI), or the like and exchange information (data, signals, and the like).

The processor 210 may control at least one element of the device 100 connected to the processor 210 by executing commands (for example, programs or the like). Further, the processor 210 may perform operations such as various calculations, managing, and data generation, and processing related to the present disclosure. In addition, the processor 210 may load information or the like from the memory 220 or may store the same in the memory 220.

The processor 210 may control each element of the server 110 or perform calculations or information processing about communication. Specifically, the processor 210 may control at least one element of the server 110 connected to the processor 210 by running software (or computer programs) received from another element. As an example, the processor 210 may load commands or information into the memory 220, process the commands or information stored in the memory 220, and store data resulting from processing in the memory 220. For example, the commands may be at least one of instructions, codes, or segments. The processor 210 is connected to the elements of the server 110 and may perform operations such as various calculations, managing, generation, or processing related to the present disclosure.

The memory 220 may store various pieces of information. The information stored in the memory 220 is information acquired, processed, or used by at least one element of the server 110 and may include software. The software may include one or more commands that, when loaded into the memory 220, cause the processor 210 to perform operations according to various embodiments of the present disclosure. That is, the processor 210 may perform operations according to various embodiments of the present disclosure by executing the one or more commands. The memory 220 may include, for example, a volatile or nonvolatile memory. In an embodiment, the program is software stored in the memory 220 and may include an operating system for controlling resources of the server 110, applications, or middleware providing various functions to the applications so that the applications can utilize resources of the server 110.

In an embodiment, the server 110 may further include a communication interface 230. The communication interface 230 may be omitted from the server 110 according to an embodiment. The communication interface 230 may establish a wired or wireless communication channel with another device and transmit and receive various pieces of information to and from the other device. The communication interface 230 may be implemented as a circuit or a chip configured to transmit and receive data. In another embodiment, the communication interface 230 may include at least one port to be connected to another device through a wired cable in order to communicate with the other device by wire. In this case, the communication interface 230 may communicate with the another device connected by wire through at least one port. In an embodiment, the communication interface 230 may include a cellular communication module and may be configured to be connected to a cellular network (for example, 3G, LTE, 5G, Wibro, or Wimax). In an embodiment, the communication interface 230 may include a short-range communication module, and transmit and receive data to and from the other device through short-range communication (for example, Wi-Fi, Bluetooth, Bluetooth low energy (BLE), or UWB). In an embodiment, the communication interface 230 may include a contactless communication module for contactless communication. The contactless communication may include at least one contactless proximity communication technology, for example, near field communication (NFC), radio-frequency identification (RFID) communication, or magnetic secure transmission (MST) communication. In addition to the foregoing various examples, the server 110 may be implemented in various known methods for communicating with another device, and the scope of the present disclosure is not limited by the foregoing examples.

In an embodiment, the server 110 may further include an output unit 240. The output unit 240 may display various screens, based on control of the processor 210. The output unit 240 is a component capable of interacting with the user, and may display various screens, based on control of the processor 210, and receive a user input from the user. The output unit 240 may be implemented in a form of a touch sensor panel (TSP) capable of recognizing contact with or proximity of various external objects (for example, a finger, a stylus, and the like). A touch sensor panel may have various structures and types, and the content disclosed herein may be applied regardless of the structure and the type of the touch sensor panel. The output unit 240 may be omitted from the server 110 depending on embodiments.

In an embodiment, the server 110 may further include an input unit 250. The input unit 250 may receive data to be used in a component (for example, the processor 210) of the server 110 from the outside (for example, the user) of the server 110. For example, the input unit 250 may be a mouse, a keyboard, or the like. The input unit 250 may be omitted from the server 110 depending on an embodiment.

In another embodiment, the user terminals 120 and 130 may include one or more processors and/or one or more memories. Each of the user terminals 120 and 130 and each of the processors thereof may interact with the server 110 to implement the technology for detecting a fraud disclosed herein. The user terminals 120 and 130 may further include a communication interface, an output unit, and/or an input unit. The configuration of the user terminals 120 and 130 are only an example, and is not limited thereto herein.

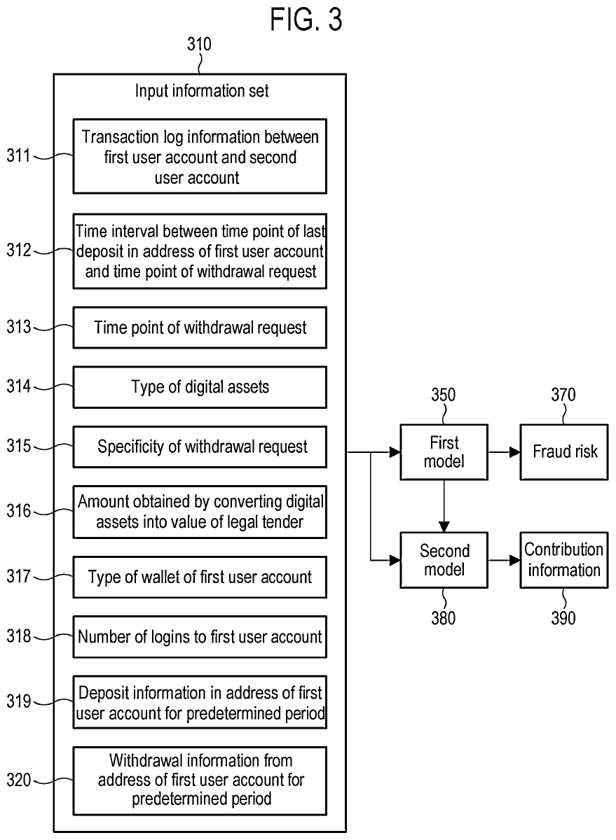

FIG. 3 is a diagram illustrating a method of calculating a fraud risk and contribution information according to an embodiment disclosed herein. In an embodiment, an input information set 310 may be an information set input into a first model 350. The input information set 310 may include at least one piece of input information selected from transaction log information 311 between a first user account and a second user account, a time interval 312 between a time point of the last deposit in an address of the first user account and a time point of a withdrawal request, a time point 313 of the withdrawal request, a type 314 of digital assets requested to be withdrawn, a specificity 315 of the withdrawal request, an amount 316 obtained by converting digital assets requested to be withdrawn into a value of legal tender, a type 317 of a wallet of the first user account, a number 318 of logins to the first user account, deposit information 319 in the address of the first user account for a predetermined period, or withdrawal information 320 from the address of the first user account for a predetermined period.

The time point 313 of the withdrawal request may be a time point at which the first user account makes a request for withdrawal to transmit digital assets to the address of the second user account. The fraud risk may increase according to the time point 313 of the withdrawal request. For example, as the time point 313 of the withdrawal request corresponds to the evening or early morning hours, the server 110 may acquire a high fraud risk from the first model 350.

The type 314 of digital assets requested to be withdrawn may be determined according to various references. For example, when the type 314 of digital assets is determined according to a function, the type 314 of digital assets may be payment tokens, utility tokens, or security tokens. In another example, the type 314 of digital assets may be determined based on the trading volume of digital assets. The type 314 of digital assets may be determined as a mainstream digital asset group having a high trading volume and a nonmainstream digital asset group having a low trading volume. By determining the type 314 of digital assets, the server 110 may compare the type 314 of digital assets traded by the first user account in the past and the type 314 of digital assets of digital assets requested to be withdrawn. When the types 314 of digital assets are the same, based on the comparison result, the server 110 may determine that the fraud risk is high.

The specificity 315 of the withdrawal request may indicate a degree of dissimilarity between the withdrawal request and a deposit-withdrawal pattern. For example, when a deposit-withdrawal pattern of the first user account does not exceed one million won but a specific withdrawal request of the first user account is a request for withdrawing 100 million won, the specificity 315 of the withdrawal request may increase. The server 110 may determine the specificity of the withdrawal request, based on the deposit-withdrawal pattern shown in a deposit-withdrawal record of the first user account for a preset period. The fraud risk 370 acquired from the first model 350 may increase in proportion to the specificity 315 of the withdrawal request.

The amount 316 obtained by converting the digital assets requested to be withdrawn into the value of legal tender may be an amount converted into a value of specific legal tender selected by the user. For example, when a request for withdrawing one Bitcoin corresponding to the digital asset is made, the amount 316 may be an amount obtained by converting one Bitcoin into a value of US legal tender (USD). Every digital asset has a different amount obtained by converting a transaction unit into a value of legal tender. Accordingly, the server 110 may use the amount obtained by converting digital assets into the value of legal tender as input information of the first model 350 in order to calculate the fraud risk. As the amount 316 is larger, the server 110 may acquire a higher fraud risk through the first model 350.

The type 317 of the wallet of the first user account may indicate whether the wallet is a wallet of the exchange or a wallet of a personal user account. Based on the number of transactions of a specific wallet, the server 110 may indicate a degree of a possibility that the corresponding wallet is the exchange wallet or a degree of a possibility that the corresponding wallet is the personal wallet. For example, the type 317 of the wallet of the first user account may be closer to the number 2 indicating the exchange wallet as the number of transactions of the corresponding wallet is larger, and may be closer to the number 0 indicating the wallet of the personal user account as the number of transactions is smaller. When there is no clear information on whether the wallet is the exchange wallet or the wallet of the personal user account, the server 110 may determine the type of the wallet, based on the number of transactions of the wallet. The fraud risk may be lower as the possibility of the exchange wallet is higher, and the fraud risk may be higher as the possibility of the wallet of the personal user account is higher.

In another embodiment, the server 110 may determine wallet classification corresponding to the address of the second user account among wallet classification based on the number of transactions recorded within a predetermined time interval. The server 110 may acquire the fraud risk 370 by further inputting information indicating the determined wallet classification into the first model 350. When the wallet classification corresponding to the address of the second user account is the exchange wallet, the fraud risk 370 may be low. In this case, the first user account trades with the exchange, and thus the possibility of a fraud is low. In contrast, when the wallet classification corresponding to the address of the second user account is the wallet of the personal user account, the fraud risk 370 may be high. This is because digital assets are highly likely to be deposited in the wallet of the personal user account in a fraud such as voice phishing.

The number 318 of logins to the first user account may be the number of times the first user account logs into the asset trading platform for a predetermined period. The number 318 of logins to the first user account may include the number of logins through a specific Internet protocol (IP) of the first user account or the number of logins through the first user terminal 120. As the number of logins is smaller, there may be a high possibility that the user uses the first user account for a fraud that the user has not used. Accordingly, the server 110 may acquire the high fraud risk 370 through the first model 350 as the number 318 of logins is lower.

The deposit information 319 in the address of the first user account for a predetermined period and the withdrawal information 320 from the address of the first user account for a predetermined period may include information on transactions through the address of the first user account for a predetermined period. When there is no deposit information 319 and withdrawal information 320, it is highly likely that the address of the first user account is a newly generated wallet, and thus there may be a high possibility that the corresponding wallet is a wallet generated for the purpose of a fraud. Accordingly, as the number of transactions of the address of the first user account acquired through the deposit information 319 and the withdrawal information 320 is low or zero, the server 110 may acquire the high fraud risk 370 through the first model 350.

In an embodiment, the server 110 may select at least some pieces of input information in the input information set 310 and input the same into the first model 350. The first model 350 may be a model that trained the correlation between the input information set 310 and the fraud risk 370. Training information may include label information corresponding to the classification result indicating whether the input information included in the input information set 310 is fraudulent. The server 110 may allow the first model 350 to have supervised learning, based on the training information. Accordingly, the server 110 may acquire the fraud risk 370 in consideration of diverse variables.

In an embodiment, the server 110 may acquire information that describes the fraud risk 370, acquired through the first model 350, through a second model 380. Specifically, the server 110 may acquire the contribution information 390 indicating a contribution to determination of the fraud risk 370 through the second model 380. The server 110 may transmit the contribution information 390 to the first user terminal 120 and/or an external device.

The second model 380 may be a model trained to calculate a contribution of each of the input information included in the input information set 310 to determination of the fraud risk 370. For example, when the transaction log information 311, the time interval 312, and the time point 313 of the withdrawal request are input into the first model 350 and the fraud risk 370 is acquired, the server 110 may acquire the contribution of each of the transaction log information 311, the time interval 312, and the time point 313 of the withdrawal request through the second model 380. In an embodiment, the server 110 may acquire the contribution information 390 by inputting input information selected from the input information set 310 and the first model 350 into the second model 380. In another embodiment, the sever 110 may acquire the contribution information 390 by inputting input information selected from the input information set 310 and the fraud risk 370 corresponding to the corresponding input information into the second model 380. The second model 380 may be, for example, a model to which SHapley Additive explanations (SHAP) is applied.

For example, the server 110 may acquire contribution information indicating the contribution of each of the transaction log information 311 and the time interval 312 to determination of the fraud risk 370 by inputting the transaction log information 311 and the time interval 312 into the second model 380. The contribution information may be expressed such that the contribution of the transaction log information 311 is 70% and the contribution of the time interval 312 is 30%. The second model 380 may be a model trained to acquire contribution information of each of the transaction log information 311 and the time interval 312, based on the fraud risk 370 acquired for each combination after a plurality of combinations of the transaction log information 311 and the time interval 312 is input into the first model 350.

In an embodiment, the server 110 may generate a new fraud detection reference, based on the contribution information. The new fraud detection reference may be a reference for determining whether each piece of input information is fraudulent based on weights assigned to the input information.

For example, the server 110 may generate third training information corresponding to the withdrawal request, based on the contribution information. Based on the contribution information, the server 110 may generate third training information such that a weight is set to be higher as the contribution of specific information is higher. The server 110 may train the first model 350, based on the third training information. For example, when the fraud risk 370 is at a level corresponding to the fraud, the contribution of the transaction log information 311 is 70%, and the time interval 312 is 30%, the first model may be trained to make the weight of the fraud risk 370 large and the weight of the time interval 312 small. As the first model 350 is trained to assign the weight to each piece of the input information, a new fraud detection reference may be generated.

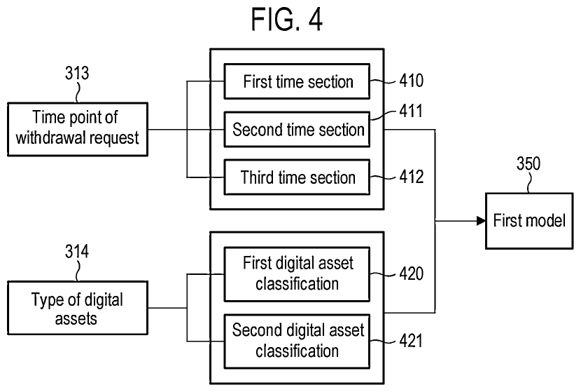

FIG. 4 is a diagram illustrating a method of processing input information according to an embodiment of the present disclosure. In an embodiment, the server 110 may determine a time section corresponding to the time point 313 of the withdrawal request among a plurality of time sections. The time section refers to a time interval. For example, the server 110 may determine whether the time point 313 of the withdrawal request corresponds to one of a first time section 410, a second time section 411, or a third time section 412. The first time section 410 may be 6:00 to 12:00 corresponding to the morning, the second time section 411 may be 12:00 to 18:00 corresponding to the afternoon, and the third time section 412 may be 18:00 to 24:00 and 00:00 to 06:00 corresponding to the evening and the dawn. The server 110 may more accurately determine whether the time point 313 of the corresponding withdrawal request is fraudulent by converting the time point 313 of the withdrawal request into a time section that is not a specific time and inputting the same into the first model 350. It may be highly likely that the reference for determining a fraud is a specific time zone rather than a specific time point. Accordingly, the server 110 may convert the time point 313 of the withdrawal request into a specific time section. The number of time sections is only an example, and may be three or more or three or less, but the present disclosure is not limited thereto.

In an embodiment, the server 110 may determine digital asset classification corresponding to the digital assets requested to be withdrawn among digital asset classifications based on the trading volume. Each digital asset may be assigned a ticker symbol. For example, each digital asset such as Bitcoin, Ethereum, or Dogecoin is assigned a ticker symbol, and the corresponding ticker symbol may be input into the first model 350. However, it may be less likely that specific digital assets are frequently used for fraud.

Accordingly, the server 110 may input the type 314 of digital assets into the first model 350. The server 110 may determine digital assets as a first digital asset classification 420 or a second digital asset classification 421, based on the trading volume. The type of the corresponding digital assets may be determined as the first digital asset classification 420 (for example, Bitcoin, Ethereum, or the like) when the trading volume of the specific digital assets is larger than or equal to a predetermined reference, and the type of the corresponding digital assets may be determined as the second digital asset classification 421 when the trading volume is equal to or smaller than the predetermined reference. Classifying the digital assets, based on the trading volume may be to identify whether the digital assets are mainstream or nonmainstream. The server 110 may acquire the fraud risk 370 through the first model 350, based on the type 314 of the digital assets. For example, when the user trades digital assets corresponding to the first digital asset classification 420 and then trades digital assets corresponding to the second digital asset classification 421, the fraud risk 370 may decrease. This is because a type of digital asset different from the existing one is more likely to be a normal transaction. In contrast, it is highly likely that trading of the type of digital asset which is the same as the existing one is fraudulent.

As described above, the server 110 may increase the accuracy of the first model 350 by processing the input information to be in a form suitable for calculating the fraud risk.

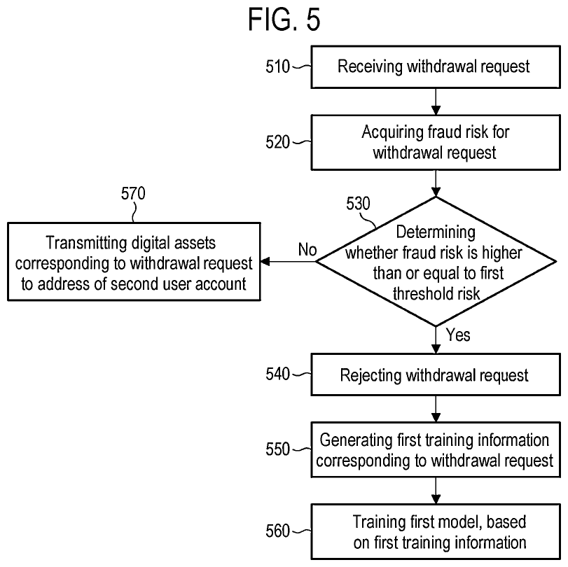

FIG. 5 is a flowchart illustrating a method of generating first training information

according to an embodiment disclosed herein. In an embodiment, the server 110 may receive a withdrawal request for transmitting digital assets to an address of a second user account from the first user terminal 120. The server 110 may acquire a fraud risk of the withdrawal request by using the first model 350 in operation 520. The server 110 may determine (decide) whether the fraud risk 370 is higher than or equal to a first threshold risk in operation 530.

According to a result indicating that the fraud risk 370 is higher than or equal to the first threshold risk, the server 110 may reject the withdrawal request in operation 540. The server 110 may transmit information indicating that the withdrawal request is rejected to the first user terminal 120.

According to a result indicating that the fraud risk 370 is lower than the first threshold risk, the server 110 may transmit digital assets corresponding to the withdrawal request to the address of the second user account. The server 110 may transmit information indicating that the withdrawal request is completed to the first user terminal 120.

According to a determination that the fraud risk 370 is higher than or equal to the first threshold risk, the server 110 may generate first training information corresponding to the withdrawal request in operation 550. The server 110 may train the first model, based on the first training information in operation 560.

In an embodiment, the server 110 may acquire the fraud risk 370 by inputting the transaction log information 311 and the time interval 312 into the first model 350. According to the determination that the fraud risk 370 is higher than or equal to the first threshold risk, the server 110 may have the transaction log information 311 and the time interval 312 as input information and generate first training information including label information indicating that the corresponding input information is fraudulent. Accordingly, the server 110 may train the first model 350 based on a newly detected fraud. The input information is only an example, and may further include other input information in the input information set 310.

In an embodiment, the server 110 may determine whether a transaction pattern corresponding to the input information and the withdrawal request is at least one of the predetermined fraud patterns. The predetermined fraud patterns may be fraud patterns pre-trained by the first model 350. For example, the server 110 may determine whether a transaction pattern corresponding to the transaction log information 311, the time interval 312, and the withdrawal request is at least one of the predetermined fraud patterns. When the transaction pattern does not correspond to the predetermined fraud patterns, the transaction pattern may be a new fraud pattern. According to the determination that the transaction pattern is not a predetermined fraud pattern, the server 110 may determine, as first training information, label information indicating that the transaction log information 311, the time interval 312, and the withdrawal request are fraudulent. The server 110 may train the first model 350 based on the first training information. Accordingly, the server 110 may train the first model 350 only for a new fraud pattern without training pre-trained fraud patterns.

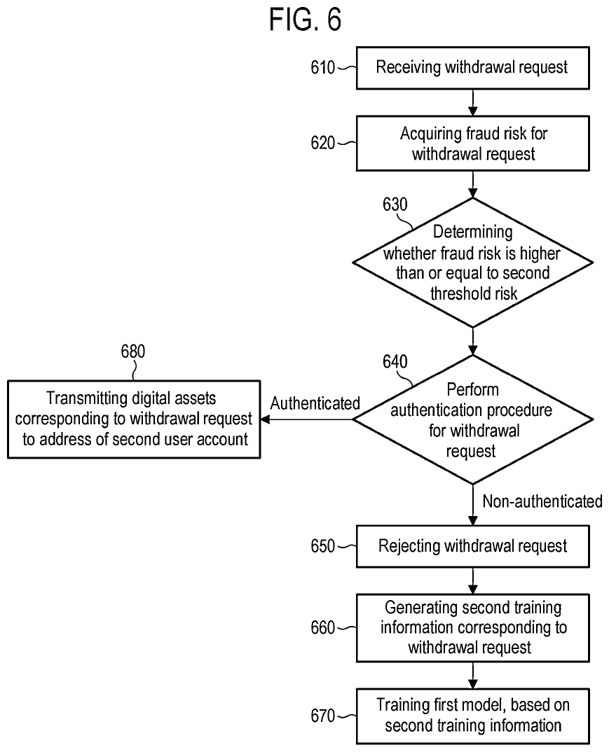

FIG. 6 is a flowchart illustrating a method of generating second training information according to an embodiment disclosed herein. In an embodiment, the server 110 may receive a withdrawal request for transmitting digital assets to an address of a second user account from the first user terminal 120. The server 110 may acquire a fraud risk of the withdrawal request by using the first model 350 in operation 620. The server 110 may determine (decide) whether the fraud risk 370 is higher than or equal to a second threshold risk in operation 630. The second threshold risk may be the same as or different from the first threshold risk.

According to a determination that the fraud risk 370 is higher than the second threshold risk, the server 110 may perform an authentication procedure for the withdrawal request in operation 640. The authentication procedure may be a procedure for identifying whether the withdrawal request is a valid request. The server 110 may transmit an authentication request to the first user terminal 120. According to the result of authentication received from the first user terminal 120, the server 110 may determine whether the withdrawal request is authenticated.

According to the result indicating that the fraud risk 370 is lower than the first threshold risk, the server 110 may transmit digital assets corresponding to the withdrawal request to the address of the second user account. The server 110 may transmit information indicating that the withdrawal request is completed to the first user terminal 120.

According to the determination that the withdrawal request is not authenticated based on the authentication procedure, the server 110 may reject the withdrawal request in operation 650. The server 110 may transmit information indicating that the withdrawal request is rejected to the first user terminal 120.

According to the determination that the withdrawal request is authenticated based on the authentication procedure, the server 110 may transmit digital assets corresponding to the withdrawal request to the address of the second user account in operation 680. The server 110 may transmit information indicating that the withdrawal request is completed to the first user terminal 120.

According to the determination that the withdrawal request is not authenticated based on the authentication procedure, the server 110 may generate second training information corresponding to the withdrawal request in operation 660. The server 110 may train the first model based on the second training information in operation 670.

In an embodiment, the server 110 may acquire the fraud risk 370 by inputting the transaction log information 311 and the time interval 312 into the first model 350. According to the determination that the fraud risk 370 is higher than or equal to the second threshold risk, the server 110 may have the transaction log information 311 and the time interval 312 as input information and generate second training information including label information indicating that the corresponding input information is fraudulent. Accordingly, the server 110 may train the first model 350 based on a fraud that has not passed the authentication procedure. The input information is only an example, and may further include other input information in the input information set 310.

In an embodiment, the server 110 may determine whether the transaction pattern corresponding to the input information and the withdrawal request that has not passed the authentication procedure is at least one of the predetermined fraud patterns. For example, the server 110 may determine whether a transaction pattern corresponding to the transaction log information 311, the time interval 312, and the withdrawal request is at least one of the predetermined fraud patterns. When the transaction pattern does not correspond to the predetermined fraud pattern, the transaction pattern may be a new fraud pattern. According to the determination that the transaction pattern is not a predetermined fraud pattern, the server 110 may determine, as second training information, label information indicating that the transaction log information 311, the time interval 312, and the withdrawal request are fraudulent. The server 110 may train the first model 350 based on the second training information. Accordingly, the server 110 may train the first model 350 only for a new fraud pattern identified during a process of performing the authentication procedure without training the pre-trained fraud patterns.

In another example, not only the transaction log information 311 and the time interval 312 but also the type 314 of digital assets and the specificity 315 of the withdrawal request may be further input into the first model 350. The server 110 may determine whether the transaction pattern corresponding to the transaction log information 311, the time interval 312, the type 314 of digital assets, the specificity 315 of the withdrawal request, and the withdrawal request is at least one of the predetermined fraud patterns. According to the determination that the transaction pattern is not a predetermined fraud pattern, the server 110 may determine, as second training information, label information indicating that the transaction log information 311, the time interval 312, the type 314 of digital assets, the specificity 315 of the withdrawal request, and the withdrawal request are fraudulent. As described above, the input information may be variously configured, and the configuration of the second training information may vary depending on the configuration of the input information.

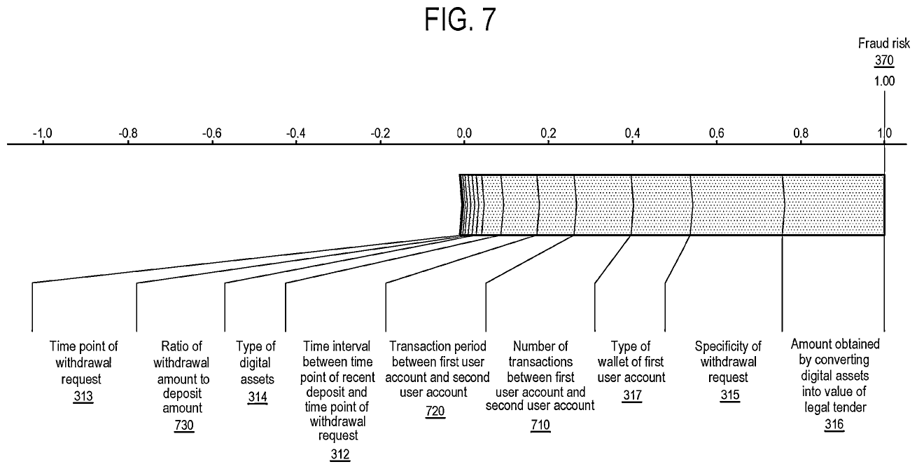

FIG. 7 is a diagram illustrating contribution information when a withdrawal request is fraudulent according to an embodiment disclosed herein. In an embodiment, the server 110 may transmit visualization information that visually provides contribution information to the user to an external device or a user terminal. Accordingly, users may identify a contribution of each of the input information to determination of a fraud risk.

Hereinafter, the case where a withdrawal request is fraudulent may be described. The fraud risk 370 acquired through the first model by the server 110 may be 1.00 and a threshold risk may be 0.5. According to a determination that the fraud risk 370 exceeds the threshold risk, the server 110 may determine that the input information of the first model 350 is fraudulent.

For example, the amount 316 obtained by converting the input digital assets input into the first model 350 into the value of legal tender is 100 million, which exceeds a predetermined reference. The larger the amount 316, the higher the probability that it corresponds to a fraud such as voice phishing or deception. When the amount 316 is large, the contribution of the amount 316 to determination of the fraud risk 370 as 1.00 may be large (for example, 20%).

For example, the specificity 315 of the withdrawal request input into the first model 350 may be high. When the amount requested to be withdrawn from the first user account is usually less than 1 million won but the corresponding withdrawal request amount is 100 million won, the specificity 315 of the withdrawal request may be higher. Since the specificity 315 of the withdrawal request is a withdrawal request which the user does not make usually, the probability of a fraud is higher as the specificity is higher. When the specificity 315 of the withdrawal request is high, the contribution of the specificity 315 of the withdrawal request to determination of the fraud risk 370 as 1.00 may be high (for example, 20%).

For example, the type 317 of the wallet of the first user account may be a wallet of a personal user account. A fraud such as voice phishing or deception may be more likely to occur in connection with a personal user account. When the type 317 of the wallet of the first user account is a wallet of the personal user account, the contribution of the type 317 of the wallet of the first user account to determination of the fraud risk 370 as 1.00 may be high (for example, 15%).

For example, when the number 710 of transactions between the first user account and the second user account is 0 and there is no period 720 of transactions between the first user account and the second user account, it means that the first user account has never traded with the second user account. However, when a withdrawal request is made for transmitting digital assets to the address of the second user account even though there is no past transaction with the second user account, the corresponding withdrawal request may be more likely to correspond to a fraud. Accordingly, the contribution of each of the number 710 of transactions between the first user account and the second user account and the period 720 of transactions between the first user account and the second user account may be high (for example, the contribution is 10%). The number 710 of transactions between the first user account and the second user account and the period 720 of transactions between the first user account and the second user account may be included in the transaction information 311.

For example, the time interval 312 between the time point of the last deposit and the time point of the withdrawal request may be 40 minutes, which is short. The shorter the time interval 312, the more likely it is that a large amount of money is deposited into a wallet by voice phishing and an attempt to quickly transfer the money to the perpetrator of voice phishing. Accordingly, when the time interval 312 is short, the contribution of the time interval 312 to determination of the fraud risk 370 as 1.00 may be high (for example, 10%).

For example, when the type 314 of digital assets is the first digital asset classification 420 and the first user account traded the digital assets corresponding to the first digital asset classification 420 in the past, the contribution of the type 314 of digital assets to determination of the fraud risk 370 as 1.00 may be high (for example, 8%). In the fraud pattern, there is a high possibility of the first user account making a withdrawal request for assets that were traded in the past.

For example, when the ratio 730 of a withdrawal amount to a deposit amount is 1.1, the contribution of the ratio 730 of the withdrawal amount to the deposit amount to determination of the fraud risk 370 as 1.00 may be high (for example, 7%). This is because the probability that the victim directly deposits the recently deposited digital assets to the perpetrator of voice phishing may be higher as the deposit amount is more similar to the withdrawal amount. The ratio 730 of the withdrawal amount to the deposit amount may be determined based on the deposit information 319 in the address of the first user account for a predetermined period and the withdrawal information 320 from the address of the first user account for a predetermined period.

For example, when the time point 313 of the withdrawal request is the third time section 312, the contribution of the time point 313 of the withdrawal request to determination of the fraud risk 370 as 1.00 may be high (for example, 2%). This is because when the withdrawal request corresponds to the evening or early morning hours, the probability of the fraud may be high.

As the contribution information is displayed on the screen, the user may easily check which input information had a substantial influence on determining the fraud risk.

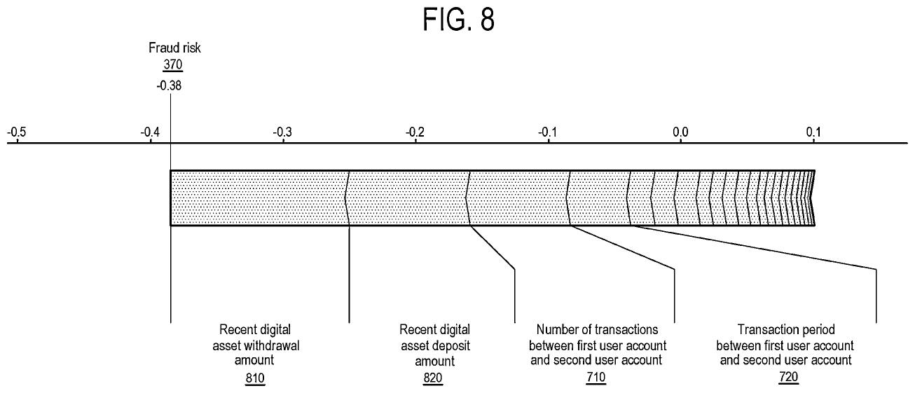

FIG. 8 is a diagram illustrating contribution information when a withdrawal request is normal according to an embodiment disclosed herein. Hereinafter, the case where the withdrawal request is normal may be described. The fraud risk 370 acquired through the first model by the server 110 may be −0.38 and a threshold risk may be 0.1. According to a determination that the fraud risk 370 is lower than the threshold risk, the server 110 may determine that the input information of the first model 350 is normal.

For example, when a recent digital asset withdrawal amount 810 is 100 thousand won and a recent digital asset deposit amount 820 is 1 million won, the deposited amount is larger than the withdrawn amount, and thus the probability that the withdrawal request is normal may be high. Each of the contribution of the recent digital asset withdrawal amount 810 and the recent digital asset deposit amount 820 to determination of the fraud risk 370 as −0.38 may be high (for example, each thereof is 25%).

For example, when the number 710 of transactions between the first user account and the second user account is 1,000 and the period 720 of transactions between the first user account and the second user account is 3 years, it can be seen that the first user account and the second user account have traded for a long period. When the two user accounts have traded for a long period, the probability of a fraud may be significantly reduced. Accordingly, each of the contributions of the number 710 of transactions between the first user account and the second user account and the period 720 of transactions between the first user account and the second user account to determination of the fraud risk 370 as −0.38 may be high (for example, 20%).

As the contribution information is displayed on the screen, the user may easily check which input information had a substantial influence on determining the fraud risk.

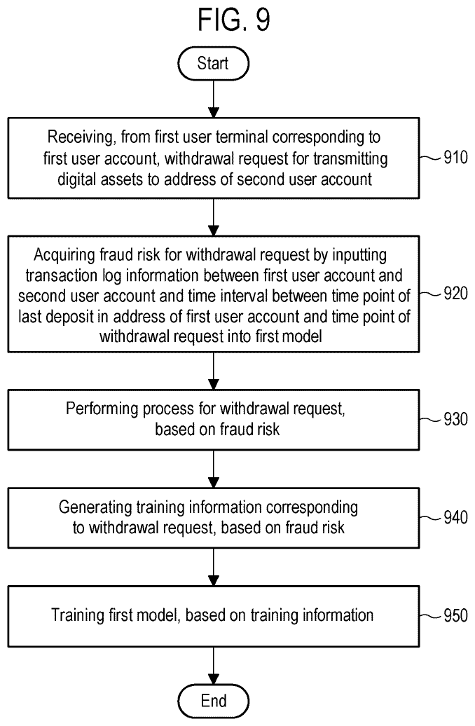

FIG. 9 is a flowchart illustrating a method of detecting a fraud according to an embodiment disclosed herein. In an embodiment, the electronic device (for example, the server 110) may receive, from a first user terminal corresponding to a first user account, a withdrawal request for transmitting digital assets to an address of a second user account in operation 910.

In an embodiment, the electronic device may acquire a fraud risk for the withdrawal request by inputting, into a first model, transaction log information between the first user account and the second user account and a time interval between a time point of the last deposit in the address of the first user account and a time point of the withdrawal request in operation 920.

In an embodiment, the electronic device may process the withdrawal request, based on the fraud risk in operation 930. In an embodiment, the electronic device may generate training information corresponding to the withdrawal request, based on the fraud risk in operation 940. In an embodiment, the electronic device may train the first model based on the training information in operation 950.

In an embodiment, the electronic device may determine whether the fraud risk is higher than or equal to a first threshold risk. According to the determination that the fraud risk is higher than or equal to the first threshold risk, the electronic device may transmit information indicating that the withdrawal request is rejected to the first user terminal. According to the determination that the fraud risk is lower than the first threshold risk, the electronic device may transmit digital assets corresponding to the withdrawal request to the address of the second user account.

In an embodiment, according to the determination that the fraud risk is higher than or equal to the first threshold risk, the electronic device may generate first training information corresponding to the withdrawal request.

In an embodiment, the electronic device may train the first model based on the first training information.

In an embodiment, the electronic device may determine whether the fraud risk is higher than or equal to a second threshold risk.

In an embodiment, according to determination that the fraud risk is higher than or equal to the second threshold risk, the electronic device may perform an authentication procedure for the withdrawal request.

In an embodiment, the electronic device may determine whether the withdrawal request is authenticated according to the authentication procedure.

In an embodiment, according to a determination that the withdrawal request is not authenticated according to the authentication procedure, the electronic device may transmit information indicating that the withdrawal request is rejected to the first user terminal. According to a determination that the withdrawal request is authenticated according to the authentication procedure, the electronic device may transmit digital assets corresponding to the withdrawal request to the address of the second user account.

In an embodiment, according to a determination that the withdrawal request is not authenticated according to the authentication procedure, the electronic device may generate second training information corresponding to the withdrawal request.

In an embodiment, the electronic device may train the first model based on the second training information.

In an embodiment, the electronic device may determine, as the second training information, label information indicating that the transaction log information, the time interval, and the withdrawal request are fraudulent.

In an embodiment, the electronic device may determine whether a transaction pattern corresponding to the transaction log information, the time interval, and the withdrawal request is at least one of predetermined fraud patterns. According to determination that the transaction pattern does not correspond to the fraud patterns, the electronic device may determine, as the second training information, the label information indicating that the transaction log information, the time interval, and the withdrawal request are fraudulent.

In an embodiment, the electronic device may acquire the fraud risk by inputting input information set related to the withdrawal request into the first model.

The input information set may include at least one piece of input information selected from a time point of the withdrawal request, a type of digital asset requested to be withdrawn, a specificity of the withdrawal request, an amount obtained by converting digital assets requested to be withdrawn into a value of legal tender, a type of a wallet of the first user account, a number of logins to the first user account, deposit information in the address of the first user account for a predetermined period, or withdrawal information from the address of the first user account for a predetermined period.

In an embodiment, the electronic device may determine the specificity of the withdrawal request based on a deposit-withdrawal pattern shown in a deposit-withdrawal record of the first user account for a preset period.

In an embodiment, the electronic device may determine a time section corresponding to the time point of the withdrawal request among a plurality of time sections. The electronic device may acquire the fraud risk by further inputting information indicating the determined time section into the first model.

In an embodiment, the electronic device may determine a digital asset classification corresponding to the digital assets requested to be withdrawn among digital asset classifications based on a trading volume.

In an embodiment, the electronic device may acquire the fraud risk by further inputting information indicating the determined digital asset classification into the first model.

In an embodiment, the electronic device may determine a wallet classification corresponding to an address of the second user account among wallet classifications based on a number of transactions recorded within a predetermined time interval.

In an embodiment, the electronic device may acquire the fraud risk by further inputting information indicating the determined wallet classification into the first model.

In an embodiment, the electronic device may acquire contribution information indicating a contribution of each of the transaction log information and the time interval applied to determination of the fraud risk by inputting the first model, the transaction log information, and the time interval into a second model.

In an embodiment, the electronic device may input the input information set into the second model and acquire contribution information indicating a contribution of each piece of input information in the input information set to determination of the fraud risk.

In an embodiment, the electronic device may generate third training information corresponding to the withdrawal request based on the contribution information.

In an embodiment, the electronic device may train the first model based on the third training information.

According to at least one embodiment disclosed herein, it is possible to identify whether a withdrawal request is fraudulent by using a machine learning-based model.

According to at least one embodiment disclosed herein, it is possible to generate training information related to a withdrawal request identified as a fraud and update the model, based on the generated training information.

According to at least one embodiment disclosed herein, it is possible to perform an authentication procedure for a withdrawal request suspected of being a fraud among withdrawal requests.

According to at least one embodiment disclosed herein, it is possible to generate training information related to a withdrawal request that has not been authenticated and update the model, based on the generated training information.

According to at least one embodiment disclosed herein, it is possible to determine a contribution to determination of a fraud risk for a withdrawal request.

The effects according to the technical idea of the present disclosure are not limited to the above-mentioned effects, and other effects that have not been mentioned may be clearly understood by those skilled in the art from the description of the present disclosure.

The methods according to the present disclosure may be methods implemented by a computer. The computer may include, for example, a device capable of performing processing. Although operations of the methods are shown and described in a predetermined order in the present disclosure, the operations may be performed according to an order in which the operations may be randomly combined in addition to being sequentially performed. In an embodiment, at least some operations may be performed in parallel, repeatedly, or heuristically. The present disclosure does not exclude changes or modifications to the methods. In an embodiment, at least some operations may be omitted, or other operations may be added.

Various embodiments of the present disclosure may be implemented in software recorded in a machine-readable recording medium. The software may be software for implementing various embodiments of the present disclosure. The software may be inferred from various embodiments of the present disclosure by programmers in the technical field to which the present disclosure belongs. For example, the software may be machine-readable instructions (e.g., code or code segments) or a program. A machine may be a device capable of operating according to instructions loaded from the recording medium, and may be, for example, a computer. In an embodiment, the machine may be a device according to embodiments of the present disclosure. In an embodiment, a processor of the machine may execute the loaded instructions to cause elements of the machine to perform functions corresponding to the instructions. In an embodiment, the processor may be a processor according to embodiments of the present disclosure. The recording medium may refer to any type of recording medium storing machine-readable data. The recording medium may include, for example, a ROM, a RAM, a CD-ROM, a magnetic tape, a floppy disk, an optical data storage device, and the like. In an embodiment, the recording medium may be a memory. In an embodiment, the recording medium may be configured in a distributed form in a computer system connected to a network. The software may be stored and executed in a distributed manner in the computer system. The recording medium may be a non-transitory recording medium. The non-transitory recording medium refers to a tangible medium regardless of storing data semi-permanently or temporarily, and does not include a transitorily transmitted signal.

Although the technical idea of the present disclosure has been described with reference to various embodiments, the technical idea of the present disclosure may include various substitutions, modifications, and changes that may be made within the scope of understanding by those skilled in the art to which the present disclosure belongs. Further, the substitutions, modifications, and changes should be understood as being included in the scope of the accompanying claims. The embodiments according to the present disclosure may be combined with each other. Various combinations of the embodiments may be made depending on a number of cases, and a combined embodiment may also be included in the scope of the present disclosure.

What is claimed is:

1. A method performed by an apparatus comprising one or more processors and one or more memories configured to store at least one instruction executed by the one or more processors, the method comprising:
receiving, from a first user terminal corresponding to a first user account, a withdrawal request for transmitting digital assets to an address of a second user account;
acquiring a fraud risk for the withdrawal request by inputting, into a first model, transaction log information between the first user account and the second user account and a time interval between a time point of a last deposit in an address of the first user account and a time point of the withdrawal request;
performing a process for the withdrawal request based on the fraud risk;
generating training information corresponding to the withdrawal request based on the fraud risk; and
training the first model based on the training information.

2. The method of claim 1, wherein the first model is a model trained based on training information having, as input information, transaction log information between two user accounts among a plurality of user accounts and a time interval between a time point of a last deposit in an address of one of the two user accounts and a time point of a withdrawal request, and
wherein the training information has, as label information, a classification result indicating whether the input information is fraudulent.

3. The method of claim 1, wherein the performing the process for the withdrawal request includes:
determining whether the fraud risk is higher than or equal to a first threshold risk; and
transmitting, to the first user terminal, information indicating that the withdrawal request is rejected, based on a determination that the fraud risk is higher than or equal to the first threshold risk, and transmitting digital assets corresponding to the withdrawal request to the address of the second user account, based on a determination that the fraud risk is lower than the first threshold risk.

4. The method of claim 3, wherein the generating the training information corresponding to the withdrawal request includes:
generating first training information corresponding to the withdrawal request based on the determination that the fraud risk is higher than or equal to the first threshold risk, and
wherein the training of the first model, based on the training information, comprises training the first model based on the first training information.

5. The method of claim 1, wherein the performing the process for the withdrawal request includes:
determining whether the fraud risk is higher than or equal to a second threshold risk;
performing an authentication procedure for the withdrawal request based on a determination that the fraud risk is higher than or equal to the second threshold risk;
determining whether the withdrawal request is authenticated based on the authentication procedure; and
transmitting, to the first user terminal, information indicating the withdrawal request is rejected, based on a determination that the withdrawal request is not authenticated based on the authentication procedure, and transmitting digital assets corresponding to the withdrawal request to the address of the second user account based on a determination that the withdrawal request is authenticated based on the authentication procedure.

6. The method of claim 5, wherein the generating the training information corresponding to the withdrawal request includes:
generating second training information corresponding to the withdrawal request based on the determination that the withdrawal request is not authenticated based on the authentication procedure, and
wherein the training the first model, based on the training information, comprises training the first model, based on the second training information.

7. The method of claim 6, wherein the generating the second training information corresponding to the withdrawal request includes:
determining, as the second training information, label information indicating that the transaction log information, the time interval, and the withdrawal request are fraudulent.

8. The method of claim 6, wherein the generating the second training information corresponding to the withdrawal request includes:
determining whether a transaction pattern corresponding to the transaction log information, the time interval, and the withdrawal request is at least one of predetermined fraud patterns; and
determining, as the second training information, label information indicating that the transaction log information, the time interval, and the withdrawal request are fraudulent based on a determination that the transaction pattern does not correspond to the fraud patterns.

9. The method of claim 1, wherein the acquiring the fraud risk for the withdrawal request includes:
acquiring the fraud risk by inputting an input information set related to the withdrawal request into the first model, and
wherein the input information set includes at least one of input information selected from:
a time point of the withdrawal request,
a type of digital asset requested to be withdrawn,
a specificity of the withdrawal request,
an amount obtained by converting digital assets requested to be withdrawn into a value of legal tender,
a type of a wallet of the first user account,
a number of logins to the first user account,
deposit information in the address of the first user account for a predetermined period, or
withdrawal information from the address of the first user account for a predetermined period.

10. The method of claim 9, wherein the acquiring the fraud risk for the withdrawal request further includes:
determining the specificity of the withdrawal request based on a deposit-withdrawal pattern shown in a deposit-withdrawal record of the first user account for a preset period.

11. The method of claim 10, wherein the specificity of the withdrawal request indicates a degree of dissimilarity between the withdrawal request and the deposit-withdrawal pattern, and
wherein the fraud risk acquired from the first model increases in proportion to the specificity of the withdrawal request.

12. The method of claim 9, wherein the acquiring the fraud risk for the withdrawal request further includes:
determining a time section corresponding to the time point of the withdrawal request among a plurality of time sections; and
acquiring the fraud risk by further inputting information indicating the determined time section into the first model.

13. The method of claim 9, wherein the acquiring the fraud risk for the withdrawal request further includes:
determining a digital asset classification corresponding to the digital assets requested to be withdrawn, among digital asset classifications based on a trading volume; and
acquiring the fraud risk by further inputting information indicating the determined digital asset classification into the first model.

14. The method of claim 9, wherein the acquiring the fraud risk for the withdrawal request further includes:
determining a wallet classification corresponding to an address of the second user account among wallet classifications based on a number of transactions recorded within a predetermined time interval; and
acquiring the fraud risk by further inputting information indicating the determined wallet classification into the first model.

15. The method of claim 1, further comprising:
acquiring contribution information indicating a contribution of each of the transaction log information and the time interval to determination of the fraud risk by inputting the first model, the transaction log information, and the time interval into a second model; and
transmitting the contribution information to the first user terminal,
wherein the second model is a model trained to input a plurality of combinations of the transaction log information and the time interval into the first model and acquire contribution information of each of the transaction log information and the time interval, based on a fraud risk acquired for each of the combinations.

16. The method of claim 9, further comprising:
inputting the input information set into a second model and acquiring contribution information indicating a contribution of each piece of input information in the input information set to determination of the fraud risk; and
transmitting the contribution information to the first user terminal,
wherein the second model is a model trained to acquire contribution information for each piece of the input information, based on a fraud risk acquired for each of a plurality of combinations of the input information by inputting the plurality of combinations of the input information into the first model.

17. The method of claim 16, further comprising:
generating third training information corresponding to the withdrawal request based on the contribution information; and
training the first model based on the third training information.

18. The method of claim 17, wherein the generating the third training information includes:
generating the third training information such that a weight is set to be higher as a contribution of indicated input information increases, based on the contribution information.

19. An apparatus comprises:
one or more processors; and
one or more memories configured to store at least one instruction executed by the one or more processors,
wherein the one or more processors are configured to execute the at least one instruction to:
receive, from a first user terminal corresponding to a first user account, a withdrawal request for transmitting digital assets to an address of a second user account;
acquire a fraud risk for the withdrawal request by inputting, into a first model, transaction log information between the first user account and the second user account and a time point of a last deposit in an address of the first user account;
perform a process for the withdrawal request based on the fraud risk;
generate training information corresponding to the withdrawal request based on the fraud risk; and
train the first model based on the training information.

20. A non-transitory computer-readable recording medium recording at least one instruction executed by one or more processors,
wherein the at least one instruction causes the one or more processors to:
receive, from a first user terminal corresponding to a first user account, a withdrawal request for transmitting digital assets to an address of a second user account;
acquire a fraud risk for the withdrawal request by inputting, into a first model, transaction log information between the first user account and the second user account and a time point of a last deposit in an address of the first user account;
perform a process for the withdrawal request based on the fraud risk;
generate training information corresponding to the withdrawal request based on the fraud risk; and
train the first model based on the training information.
